(19) United States
(12) Patent Application Publication
(10) Pub. No.: US 2007/0188013 A1
(43) Pub. Date: Aug. 16, 2007

(54) Hydraulically powered air charging arrangement

(76) Inventors: Fred W. Hoffman, Columbia Station, OH (US); Leonard A. Quinn, Lagrange, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/355,712

(22) Filed: Feb. 16, 2006

(51) Int. Cl. B60T 13/16

(52) U.S. Cl. 303/10

(57) ABSTRACT

An air charging arrangement for an air brake system of a vehicle driven by an internal combustion engine. The arrangement includes a hydraulic motor for driving an air compressor, which is mounted to the vehicle at a location that is thermally isolated from the engine. The arrangement may also include an air compressor controller that places the air compressor in a non-operating state when air pressure in an air reservoir is at or above a predetermined amount. In one embodiment, the air compressor is self-lubricated and air cooled.

### BACKGROUND

Air compressors are used on some vehicles to provide compressed air for on-board systems, such as for example, an air brake system or an air suspension system. Various types of air compressors are available, for example, piston style air compressors have been proven suitable for on-board compressed air systems. Piston style air compressors generally include a rotatable crankshaft for converting a rotational input to a linear movement of the piston for intaking and compressing ambient air.

Customarily, these air compressors are mounted to, and driven by, the vehicle's internal combustion engine. A rotating shaft of the internal combustion engine is typically coupled to the rotatable crankshaft of the air compressor via a set of gears; thus, the air compressor is driven directly by the engine. In addition to the air compressor, the rotating engine shaft is often used to drive additional vehicle components, such as for example, a fuel pump or power steering pump. Furthermore, the air compressor is also typically lubricated and cooled by engine oil and engine coolant, respectively.

In operation, rotating the engine shaft rotates the air compressor crankshaft. As a result, the air compressor supplies compressed air, which is typically stored in an on-board tank or reservoir. When the reservoir is full, an unloader mechanism, as is known in the art, is used to stop the compressor from further filling the reservoir. Although the compressor is still running, the unloader mechanism ensures that no compressed air is delivered to the compressed air system by, for example, dumping the compressed air produced by the compressor to atmosphere.

Using the engine to directly drive the compressor is a convenient way of providing compressed air for a commercial vehicle. Doing so, however, necessitates that the compressor be mounted to the engine. As a result, the compressor resides in, and is exposed to, a high temperature environment in the engine compartment. Furthermore, unless a special clutch type mechanism is added to the system, the direct drive coupling between the engine and the compressor results in the air compressor running whenever the engine is running, even if no compressed air is required. These factors lead to increased oil carryover (i.e. oil being transferred from the compressor into the air lines). Increased oil carryover results because high temperature promotes the formation of fine oil aerosols and rotating the crankshaft in the unloaded mode results in more oil getting past the piston rings of the compressor. Oil carryover has been a complaint of fleet owners for many years because it can degrade the performance of vehicle systems, such as the air brake system. In the past, turbo-charging the air compressor inlet helped minimize oil carryover. Recently, however, emissions regulations have made it necessary for the engine manufacturers to use exhaust gas recirculation (EGR) to meet emissions requirements. Using EGR can cause deposit and wear problems in turbochargers, thus making the use of turbo charging problematic.

### SUMMARY

An air charging arrangement is presented for an air brake system of a vehicle driven by an internal combustion engine. The arrangement includes a hydraulic motor for driving an air compressor, which is mounted to the vehicle at a location that is thermally isolated from the engine. The arrangement may also include an air compressor controller that places the air compressor in a non-operating state when air pressure in an air reservoir is at or above a predetermined amount. In one embodiment, the air compressor is self-lubricated and air cooled.

### DRAWING DESCRIPTIONS

In the accompanying drawing, which is incorporated in and constitutes a part of this specification, an embodiment of the invention is illustrated, which, together with a general description of the invention given above, and the detailed description given below, serve to illustrate the principles of this invention.

FIG. 1 is a schematic representation of an exemplary embodiment of an arrangement according to the present invention

### DETAILED DESCRIPTION

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

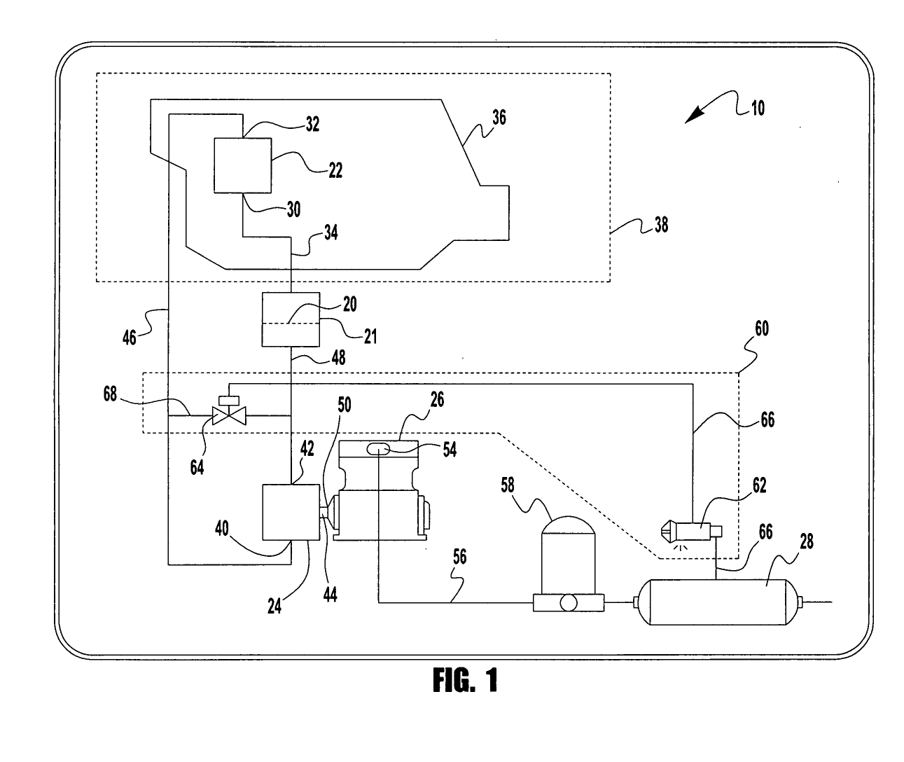

Referring to FIG. 1, an exemplary embodiment of a hydraulically powered air charging arrangement according to the present invention is presented. The arrangement 10 may be used to provide compressed air to an on-board system of a commercial vehicle, such as for example, use with a trailer truck. The arrangement 10 may also be used in the rail industry. The arrangement 10 includes a hydraulic fluid volume 20, such as for example, hydraulic fluid stored in a hydraulic fluid reservoir 21, a source of pressurized hydraulic fluid 22, such as for example, one or more hydraulic pumps, a hydraulic motor 24, an air compressor 26, and a compressed air reservoir 28. In the exemplary embodiment of FIG. 1, the source of pressurized hydraulic fluid 22 is illustrated as a hydraulic pump. The source 22, however, may be any source of pressurized hydraulic fluid suitable to drive the hydraulic motor 24. In operation, the hydraulic pump 22 drives the hydraulic motor 24 which in turn drives the air compressor 26 to supply compressed air for use by the vehicle.

The hydraulic pump 22 includes a fluid inlet 30 and a fluid outlet 32. The fluid inlet 30 is in fluid communication with the hydraulic fluid volume 20 in the hydraulic fluid reservoir 21 by suitable means, such as for example, by a hydraulic fluid line 34 connecting the pump 22 to the reservoir 20. The hydraulic pump 22 is illustrated in FIG. 1 as being coupled to, and driven by, an internal combustion engine 36. The pump 22 may be an existent accessory, such as for example, a power steering pump or a pump from a hydrostatic transmission. In which case, the existent pump may need to be upsized to meet the additional demand of driving the hydraulic motor 24. The source of pressurized hydraulic fluid 22, however, need not be an existent pump. For example, the source 22 may be one or more additional pumps used independently or in conjunction with an existent pump to supply pressurized hydraulic fluid.

The hydraulic motor 24 includes a fluid inlet 40, a fluid outlet 42, and an output member 44. The fluid inlet 40 is in fluid communication with the fluid outlet 32 of the hydraulic pump 22 by suitable means, such as for example, by a hydraulic fluid line 46 connecting the pump 22 to the hydraulic motor 24. The hydraulic motor 24 may be any suitable hydraulic motor capable of driving the air compressor 26. For example, the GHM2 model of hydraulic gear motors from TRW/Marzocchi have been found suitable. Hydraulic fluid exiting the motor 24 is returned to the reservoir 21 by suitable means, such as for example, by a hydraulic line 48 connecting the fluid outlet 42 of the motor 24 to the hydraulic fluid reservoir 21.

The output member 44 of the hydraulic motor 24 is coupled to an input member 50 of the air compressor 26 such that the motor 24 may drive the compressor. For example, the output member 44 of the hydraulic motor 24 may be a rotatable output shaft that is coupled to a rotatable input shaft, such as a crankshaft, of the air compressor 26. The air compressor 26 is in fluid communication with a source of air, such as for example, ambient air and also includes an air outlet 54. The air outlet 54 is in fluid communication with the air reservoir 28 by suitable means, such as for example, by a pneumatic line 56 connecting the air compressor 26 with the air reservoir 28.

The arrangement 10 may also include an air dryer 58, as is known in the art to be included in a vehicle air brake system. The air dryer 58 may be located in a suitable position to remove moisture from the compressed air exiting the air compressor 26, such as for example, in the pneumatic line 56 connecting the air compressor 26 to the air reservoir 28.

The arrangement 10 may also include an air compressor controller 60. The air compressor controller 60 turns the air compressor 26 off when there is a sufficient supply of compressed air in the air reservoir 28. Thus, the controller 60 may be any device or arrangement that is capable of switching the compressor 26 between a first state in which the compressor is supplying compressed air to the air reservoir 28, and a second state in which the compressor is not operating or rotating. In the example of FIG. 1, the controller 60 includes a governor 62 and a pneumatic, air-to-open valve 64. The governor 62 is in fluid communication with the air reservoir 28 and with the pneumatic valve 64 by suitable means, such as for example, by air lines 66. The pneumatic valve 64 is positioned in a bypass path 68, which may be a hydraulic line that connects the hydraulic line 46 to the hydraulic line 48.

In operation, when air pressure in the air reservoir 28 reaches or exceeds a predetermined amount, the pressure opens a port (not shown) in the governor 62 that places the reservoir 28 in fluid communication with the pneumatic valve 64. As a result, air pressure from the reservoir 28 actuates the valve 64 to an open position. When opened, the valve 64 allows hydraulic fluid to flow through the bypass path 68, which effectively diverts hydraulic fluid away from the hydraulic motor inlet 40. As a result, the hydraulic motor 24 and air compressor 26 stop rotating. Shutting the air compressor 26 off when compressed air is not needed reduces compressor wear and decreases fuel consumption.

When air pressure in the air reservoir 28 falls below a predetermined level, indicating a need to fill the air reservoir, the port (not shown) in the governor 62 closes, thus removing air pressure to the pneumatic valve 64. As a result, the valve 64 closes and the hydraulic motor 24 is again driven by the hydraulic pump 22. The air dryer 58 can be equipped with a Discharge Line Unloader (DLU) style purge valve assembly (not shown) to exhaust the pressure in the air line 56, thus reducing the start-up torque of the air compressor 26.

Because the air compressor 26 is powered by the hydraulic motor 24 and not directly by the engine 36, as is customary, the air compressor 26 may be mounted in a more desirable location or manner. In particular, when the air compressor 26 is mounted to the engine 36, the compressor is exposed to the heat generated from the engine. By driving the air compressor 26 with a hydraulic motor 24, the air compressor 26 may be located in a position that is thermally isolated from the engine 36. In the context of this application, thermally isolated means that the air compressor 26 is not exposed to a significant amount of heat from the engine 36 such that the operating temperature of the air compressor is substantially lower than would be if mounted directly to the engine. For example, the air compressor 26 may be mounted outside of the engine compartment 38, elsewhere on the chassis. Applicants have observed that by placing the air compressor 26 outside the engine compartment 38, the temperature at which the air compressor operates may be reduced by approximately 100 degrees Fahrenheit or more. Examples of a suitable locations to mount the air compressor 26 and the hydraulic motor 24 include on the vehicle chassis under or behind the cab and on a bus by the rear axle. Other locations, however, are possible. Furthermore, the air compressor 26 may be thermally isolated in other ways, such as for example, by a thermal shield. In this way, the air compressor 26 may be mounted within the engine compartment 38 and still be thermally isolated from the engine 36. Lowering the ambient operating temperature of the air compressor 26 will reduce the oil carryover by reducing the amount of fine oil aerosol.

Removing the air compressor 26 from the engine 36 also makes more space available on the engine for other accessories. Furthermore, powering the air compressor 26 with a hydraulic motor, rather than the engine 36, means that an unloader mechanism is not needed since the controller 60 and hydraulic motor 24 stop the air compressor 26.

In the exemplary embodiment of FIG. 1, the air compressor 26 may be self-cooled. For example, the air compressor 26 may be air cooled since being in a thermally isolated location, air cooling the compressor 26 is sufficient. Air-cooling the air compressor 26 provides the opportunity to reduce the weight of the air charging arrangement 10 by eliminating the compressor's coolant system and other components, such as coolant lines.

In the example of FIG. 1, the air compressor 26 may also be self-lubricated. For example, in one embodiment, the air compressor 26 may include an oil lubrication system that is independent of the engine's oil lubrication system. It is known that engine oil begins to breakdown when exposed to temperatures above 250 degrees Fahrenheit. The oil in a self-lubricated air compressor 26 would not be exposed to high temperatures; thus, the life of the compressor's oil could be extended, possibly to the point where the compressor is sealed for life. Self-lubricated and self-cooled air compressors are known in the art, such as for example, the Bendix TF-500 air compressor, available from Bendix Commercial Vehicle Systems, LLC.

A self-lubricated or oil-less air compressor 26 would be exposed to little or no oxidized engine oil, engine combustion byproducts or wear debris, or engine oil additive packages. Engine oil oxidizes over time when exposed the high operating temperatures within an engine. Oxidized oil tends to break down the rubber sealing components used in most air brake devices. In addition, engine oil has combustion byproducts like soot and debris which cause abrasive wear and shorten compressor life. Furthermore, engine oil additive packages are formulated to provide certain performance benefits for the engine, not for delivering good air compressor performance. A self lubricated air compressor, however, can use oil formulated specifically to improve air compressor performance, such as for example, to reduce oil carryover.

In another exemplary embodiment of the air charging arrangement 10, the air compressor 26 may be an oil-less/oil free air compressor. Oil-less/oil free air compressors are known in the art and the air compressor 26 may be configured similar those oil-less/oil free compressors already available. In the past, major obstacles to using oil-less air compressors on commercial vehicles have been the hot engine compartment environment and the wear that occurs due to continuous operation of the compressor when the engine is running. The hydraulically powered air charging arrangement 10 of the present invention addresses these concerns, thus providing a platform for using an oil-less/oil free air compressor. Using an oil-less/oil free air compressor may also allow the arrangement 10 to include a membrane style air dryer. A membrane air dryer would benefit the end user since it provides continuous flow of air and would likely have a longer life than today's desiccant dryers.

The air compressor 26 may be made from a variety of materials, such as for example, aluminum or high performance plastics, which may help reject heat and reduce weight. For example, in an exemplary embodiment, the air compressor 26 includes a die cast aluminum crankcase. In another exemplary embodiment, the air compressor crankcase and other compressor components may be made of a high performance plastic.

Typically, when an air compressor is mounted to an engine, many different crankcase configurations are required due to the wide variety of engine flanges used by different engine manufacturers. By locating the air compressor 26 off of the engine 36, however, a single compressor crankcase configuration may be used (i.e. one compressor fits all vehicles),

Furthermore, by removing the air compressor 26 from the engine, the truck manufacturer may realize a reduction in cost to manufacture the vehicle. For example, in the exemplary embodiment, the air charging arrangement 10 or a portion thereof may be configured in a single, preassembled module that the vehicle manufacture can simply install. For example, the module may include the hydraulic motor 24, the air compressor 26, the air dryer 58, one or more air reservoirs 28, and air distribution valves and other truck chassis mounted hardware such as a battery box, steps, etc. Thus, the air charging arrangement 10 may be delivered to the vehicle manufacturer as an assembled module that requires no assembly time, only installation. In this case, the vehicle manufacturer would only need to run two hydraulic lines to the module to power the hydraulic motor 24.

The invention has been described with reference to the preferred embodiments. Modification and alterations will occur to others upon a reading and understanding of this specification. It is intended to include all such modifications and alterations insofar as they come within the scope of the appended claims or the equivalents thereof.

1. An air charging arrangement for an air brake system of a vehicle driven by an internal combustion engine, the system comprising:
a hydraulic motor having an output member, the hydraulic motor being driven by a source of pressurized hydraulic fluid;
an air compressor having an input member driven by the output member of the hydraulic motor, the air compressor being mounted to the vehicle at a location that is thermally isolated from the engine;
an air reservoir in fluid communication with the air compressor for receiving and storing compressed air from the air compressor; and
an air compressor controller adapted to place the air compressor in a non-operating state when air pressure in the air reservoir is at or above a predetermined amount.

2. The air charging arrangement according to claim 1 further comprising a hydraulic fluid reservoir containing hydraulic fluid.

3. The air charging arrangement according to claim 2 wherein the source of pressurized hydraulic fluid is a hydraulic pump that is in fluid communication with the hydraulic fluid reservoir.

4. The air charging arrangement according to claim 3 wherein hydraulic pump is a power steering pump.

5. The air charging arrangement according to claim 1 wherein the engine resides in an engine compartment and the air compressor is mounted outside the engine compartment.

6. The air charging arrangement according to claim 1 wherein the air compressor is self-lubricated and air cooled.

7. The air charging arrangement according to claim 1 wherein the air compressor is oil-less.

8. The air charging arrangement according to claim 1 wherein the air compressor includes an aluminum crankcase.

9. The air charging arrangement according to claim 1 wherein the hydraulic pump is a power steering pump.

10. The air charging arrangement according to claim 1 further comprising an air dryer positioned to remove moisture from compressed air exiting the air compressor.

11. The air charging arrangement according to claim 1 wherein the air compressor controller comprises:
an air actuated valve positioned to divert hydraulic fluid from entering the hydraulic motor when the valve is in a first state; and
a governor in fluid communication with the compressed air in the air reservoir, wherein the governor directs the compressed air to the air valve to actuate the valve to the first state when air pressure in the air reservoir is at or greater than a predetermined amount.

12. In a vehicle air brake charging system, a controller for an air compressor, the air compressor being driven by a hydraulic motor and including an air outlet in fluid communication with an air reservoir for storing pressurized air, the hydraulic motor including a hydraulic fluid inlet, and a hydraulic fluid outlet, the controller comprising:
an air actuated valve positioned to divert hydraulic fluid from entering the hydraulic fluid inlet of the hydraulic motor when the valve is in a first state; and
a governor in fluid communication with the pressurized air in the air reservoir, wherein the governor directs the pressurized air to the air valve to actuate the valve to the first state when air pressure in the air reservoir is at or greater than a predetermined amount.

13. An air charging arrangement for an air brake system of a vehicle driven by an internal combustion engine, the system comprising:
a hydraulic motor having a rotatable output member that is rotatable in response to the motor receiving pressurized hydraulic fluid from a hydraulic pump;
an air compressor coupled to the rotatable output member for movement therewith;
an air reservoir in fluid communication with the air compressor for receiving and storing compressed air from the air compressor; and
a means for reducing oil carryover in the air compressor.

14. The air charging arrangement according to claim 13 wherein the means for reducing oil carryover comprises mounting the air compressor in a location that is thermally isolated from the engine.

15. The air charging arrangement according to claim 13 wherein the means for reducing oil carryover comprises placing the air compressor in a non-rotating state when compressed air is not needed.

16. A method of providing compressed air to an on-board compressed air system for an engine-powered vehicle, the method comprising the steps of:
supplying hydraulic fluid under pressure to drive a hydraulic motor;
compressing air with an air compressor driven by the hydraulic motor, wherein the air compressor is thermally isolated from the engine;
directing compressed air from the air compressor to an air reservoir;
placing the air compressor in a non-rotating state when air pressure in the reservoir is at or above a predetermined amount.

17. The method according to claim 16 wherein the air compressor is mounted outside of a compartment that houses the engine.

18. The method according to claim 16 wherein the air compressor is mounted off of the engine.

19. The method according to claim 16 wherein the air compressor is self-lubricated and self-cooled.

20. The method according to claim 16 wherein the air compressor is oil-less.

21. The method according to claim 16 wherein the step of placing the air compressor in a non-rotating state further comprising the step of:
diverting hydraulic fluid away from a fluid inlet of the hydraulic motor.

22. A method of reducing oil carryover in an air compressor used to supply air to an air brake system on an engine powered vehicle, the method comprising the step of:
driving the air compressor with a hydraulic motor;
thermally isolating the air compressor from the engine; and
shutting the compressor off when compressed air is not needed.

23. The method according to claim 22 wherein the air compressor is mounted outside of a compartment that houses the engine.

24. The method according to claim 22 wherein the air compressor is self-lubricated and self-cooled.

25. The method according to claim 22 wherein the hydraulic motor is driven by a power steering pump.

26. The method according to claim 22 wherein the step of shutting the compressor off when compressed air is not needed further comprising the step of:
diverting hydraulic fluid away from a fluid inlet of the hydraulic motor.
